(19) United States
(12) Patent Application Publication
(10) Pub. No.: US 2010/0239326 A1
(43) Pub. Date: Sep. 23, 2010

(54) DEVELOPING DEVICE, IMAGE FORMING APPARATUS AND IMAGE FORMING METHOD

(75) Inventors: Yoichi Yamada, Shiojiri-shi (JP); Tomohiro Aruga, Matsumoto-shi (JP); Daisuke Matsumoto, Matsumoto-shi (JP); Atsunori Kitazawa, Shiojiri-shi (JP); Masaru Kobashi, Matsumoto-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/724,845

(22) Filed: Mar. 16, 2010

(30) Foreign Application Priority Data
Mar. 23, 2009 (JP) 2009-070845

(51) Int. Cl. G03G 15/08

(52) U.S. Cl. 399/284

(57) ABSTRACT

A developing device, an image forming apparatus and an image forming method are disclosed. The developing device includes a housing that stores toner therein; a toner carrying roller that has a plurality of convex portions and concave portions surrounding the convex portions are formed on the surface of the toner carrying roller; and a conductive regulation blade having a free end comes in contact with the surface of the toner carrying roller. The toner includes a conductive external additive as an external additive. The toner carrying roller carries both contact toner which is in direct contact with the surface of the toner carrying roller and non-contact toner which is not in direct contact with the surface of the toner carrying roller, on the concave portion. The regulation blade is applied with a regulation bias voltage of the same polarity as a normal charge polarity of the toner.

### BACKGROUND

1. Technical Field

The present invention relates to a developing device including a toner carrying roller, of which a surface is provided with convex portions and concave portions, and image forming apparatus and an image forming method of forming an image by using the roller.

2. Related Art

In techniques of developing an electrostatic latent image by toner, the toner is generally carried on a surface of a toner carrying roller which is formed in a substantially cylindrical shape. Since variations in the charge amounts of the toner inevitably occur in such a technique, in particular, toner with a low charge amount or toner charged by a polarity which is reverse to the original charge polarity adheres to a portion of the image, to which the toner should not primarily adhere, so that so-called fogging occurs. Consequently, in order to increase the charge amount of the toner carried on the surface of the toner carrying roller, a configuration is disclosed in JP-A-2005-331780 (for example, FIG. 1), in which conductive toner is used as the toner, and a charge imparting member applied with a bias voltage having the same polarity as the charge polarity of the toner is placed in opposition to the toner carrying roller, thereby imparting charges to the toner on the surface of the toner carrying roller.

However, in the technique disclosed in JP-A-2005-331780, the charges are imparted to the toner originally with sufficient charge amount, so that the toner enters an excessively charged state. Such excessively charged toner may be electrostatically strongly adhered to the surface of the toner carrying roller. According to experiments of the inventors, in a case in which the electrostatic image is developed by toner including a lot of the excessively charged toner, shortages in developing concentration was likely to happen. In addition, since charge is imparted to the toner for which the charge is not necessarily needed, sufficient charge is not imparted to the toner having low charge amount for which the charge is necessary, thereby limiting the effect of suppressing fogging.

### SUMMARY

An advantage of some aspects of the invention is that it provides a developing device including a toner carrying roller, of which a surface is provided with convex portions and concave portions, and image forming apparatus and an image forming method of forming an image by using the roller, so as to prevent toner from being excessively charged on the toner carrying roller and obtain sufficient developing concentration while suppressing fogging.

According to an aspect of the invention, there is provided a developing device including: a housing that stores toner therein; a toner carrying roller that is mounted to the housing by a shaft and is rotated while carrying charged toner supplied from the housing on a surface of the toner carrying roller, in which a plurality of convex portions having top surfaces constituting a part of the same cylindrical surface and concave portions surrounding the convex portions are formed on the surface of the toner carrying roller; and a conductive regulation blade having a free end extending toward an upstream side, in a rotation direction, of the toner carrying roller, in which the free end or a neighboring portion adjacent to the free end comes in contact with the surface of the toner carrying roller to regulate an amount of the toner carried on the surface of the toner carrying roller, wherein the toner includes a conductive external additive as an external additive, the toner carrying roller carries both contact toner which is in direct contact with the surface of the toner carrying roller and non-contact toner which is not in direct contact with the surface of the toner carrying roller, on the concave portion, and the regulation blade is applied with a regulation bias voltage of the same polarity as a normal charge polarity of the toner.

According to another aspect of the invention, there is provided an image forming apparatus including: a housing that stores toner therein; a toner carrying roller that is mounted to the housing by a shaft and is rotated while carrying charged toner supplied from the housing on a surface of the toner carrying roller, in which a plurality of convex portions having top surfaces constituting a part of the same cylindrical surface and concave portions surrounding the convex portions are formed on the surface of the toner carrying roller; a conductive regulation blade having a free end extending toward an upstream side, in a rotation direction, of the toner carrying roller, in which the free end or a neighboring portion adjacent to the free end comes in contact with the surface of the toner carrying roller to regulate an amount of the toner carried on the surface of the toner carrying roller; a bias applying unit that applies a predetermined regulation bias voltage to the regulation blade; and a latent image carrier that is placed in opposite to the toner carrying roller and carries an electrostatic latent image on a surface thereof; wherein the toner includes a conductive external additive as an external additive, the toner carrying roller carries both contact toner which is in direct contact with the surface of the toner carrying roller and non-contact toner which is not in direct contact with the surface of the toner carrying roller, on the concave portion, and the regulation bias voltage has the same polarity as a normal charge polarity of the toner.

According to another aspect of the invention, there is provided an image forming method including: carrying toner on a surface of a toner carrying roller, in which a plurality of convex portions having top surfaces constituting a part of the same cylindrical surface and concave portions surrounding the convex portions are formed on the surface of the toner carrying roller; regulating an amount of the toner by bring the surface of the toner carrying roller in contact with a conductive regulation blade having a free end extending toward an upstream side, in a rotation direction, of the toner carrying roller, in which the free end or a neighboring portion adjacent to the free end comes in contact with the surface of the toner carrying roller; and placing a latent image carrier carrying an electrostatic latent image in opposite to the toner carrying roller to develop the latent image by the toner; wherein the toner includes a conductive external additive as an external additive, the toner carrying roller carries both contact toner which is in direct contact with the surface of the toner carrying roller and non-contact toner which is not in direct contact with the surface of the toner carrying roller, on the concave portion, and the regulation blade is applied with a regulation bias voltage of the same polarity as a normal charge polarity of the toner.

In this instance, the conductive external additive is used for the purpose of improving flow properties and the like in almost all of general toners. Compared with the high insulation property (>10¹⁰ Ωcm) shown by silica or resin beads, it does not show the very high conductivity of a conductor such as metal. For example, it seems that even material having resistance of about 10⁷ to 10⁸ Ωcm has relatively high conductivity as an external additive.

According to these inventions, when seen from an imaginary cylindrical surface formed by connecting the top surface of the respective convex portions, the toner is carried in the concave portion which is recessed toward a direction of rotation center of the toner carrying roller. Here, both the contact toner which is in direct contact with the surface of the toner carrying roller and the non-contact toner which is not in direct contact with the surface of the toner carrying roller, are carried in the concave portion. The contact toner has a relatively high charge amount, while the non-contact toner has low charge amount, but contains a lot of toner charged in a polarity which is reverse to the normal charge polarity of the toner. The reason is that the toner having a high charge amount, in which an electrostatic suction force acts strongly, is easily collected adjacent to the surface of the toner carrying roller, while the toner having a low charge amount or the reversely charged toner is pushed by the toner having the high charge amount and is thus carried at a position away from the surface of the toner carrying roller. That is, in the toner layer of the concave portion, its surface layer is mainly constituted of the non-contact layer having the low charge amount, while the layer coming in contact the toner carrying roller is mainly constituted of the contact toner having the high charge amount.

Although it will be hereinafter described in detail, according to various experiments of the inventors, finding is obtained showing that in a charging mechanism of charging the toner by brining the toner in contact with a conductive member applied with a bias to impart a charge to the toner and thus charge the toner, irrespective of whether the toner has the conductivity as disclosed in JP-A-2005-331780, the existence of a specific external additive imparted on the surface of the toner contributes largely to the charge of the toner. More specifically, irrespective of the conductivity of toner matrix particles themselves in the toner imparted with an appropriate amount of conductive particles as an external additive, it is possible to effectively control the charge amount of the whole toner by imparting the charge to the conductive external additive on the toner surface from the conductive member imparted with a potential of the same polarity as the normal charge polarity.

According to the invention, when the toner is in contact with the regulation blade applied with the regulation bias voltage having the same polarity as the normal charge polarity of the toner, the regulation blade is mainly in contact with the surface layer of the toner layer. For this reason, the charge from the regulation blade is intensively transferred to the non-contact toner constituting the surface layer, and the charge is not strongly transferred to the toner originally with the high charge amount. As a result, in case of the toner with a low charge amount, the charge amount increases, and a charge with normal polarity is imparted to the reversely charged toner, and thus its charge polarity is reversed. Meanwhile, the toner originally with the high charge amount which is in contact with the toner carrying roller is not in contact with the regulation blade, so that its charge amount is not changed and thus the toner is not excessively charged. Consequently, variation in the charge amount of the toner in the toner layer is low. Therefore, both the contact toner and the non-contact toner contribute to the development, thereby ensuring high developing concentration. In this way, the invention can suppress scattering of the toner or generation of fogging due to toner with a low charge amount or reversely charged toner.

According to the invention, a gap between the leading end of the free end and the concave portion of the toner carrying roller may be larger than the volume average grain size of the toner. In this way, the thickness of the toner layer carried in the concave portion exceeds one layer. Since the toner exceeding one layer inevitably includes both the contact toner and the non-contact toner, it is possible to reliably obtain the effect of the invention by setting the interval between the regulation blade and the concave portion.

In this instance, if the gap between the regulation blade and the concave portions is set to be large, since the amount of the toner carried is increased, it is possible to promote improvement of the developing concentration. However, if the toner amount is excessive, since the toner which is difficult to impart with sufficient charges, scattering or fogging may be worsen. In order to prevent the above problem, it is preferable that the gap be two times as much as the volume average grain size of the toner. In this way, the thickness of the toner layer in the concave portion becomes about two layers, and the layer of the non-contact layer becomes almost one layer. The non-contact toner is in contact with the regulation blade, and the charge amount is increased by receipt of the charges from the regulation blade, thereby suppressing scattering or fogging.

In this instance, whether or not the toner is carried on the convex portions of the toner carrying roller is optional, but it is preferable that the toner is not carried on the convex portions, for purposes of suppression of scattering or fogging. That is, the gap between the leading end of the free end and the convex portions of the toner carrying roller may be set to be 0. It is possible to previously prevent the toner from scattering on the convex portions due to wind pressure generated by the rotation of the toner carrying roller. In particular, similar to toner having a wide distribution of grain sizes, such as small-grain size toner or crushed toner, since scattering easily occurs in the toner containing particles of fine grain size, it is preferable to prevent scattering by restricting the toner carriage on the convex portions.

It is preferable that the toner includes at least one of titanium oxide, aluminum oxide, zinc oxide, cerium oxide, and tin oxide as the external additive. It is verified by the experiments of the inventors that these metal oxides effectively control the charge amount according to the configuration of the invention.

Further, the toner carrying roller may be made of metal with a surface which is subjected to an amorphous plating process. It is verified by the experiments of the inventors that the toner can be frictionally charged in the housing by the toner carrying roller. The characteristics of the toner carried on the surface of the toner carrying roller are appropriately maintained by combining the toner carrying roller and the regulation blade applied with the regulation bias voltage, thereby obtaining an image of a high quality.

In addition, the regulation bias voltage may be larger than the surface potential of the toner layer carried on the surface of the toner carrying roller. That is, at the same polarity as the normal charge polarity of the toner, its absolute value may be higher than the surface potential of the toner layer. In the contact between the regulation blade and the toner, the charge maintained by the conductive external additive leak to the regulation blade side, but if so, movement of the charge to the toner from the regulation blade is accelerated, thereby more reliably controlling the charge amount of the toner.

In this instance, if the proportion of the conductive external additives is too small in the toner, the charge control effect of the invention is low. According to the experiment of the inventors, it is preferable that the conductive external additive of at least 0.5 wt % or more is added. In particular, the appropriate result is obtained by increasing the proportion of the conductive external additive, relative to the toner added with different external additive having an insulating property, such as silica or resin beads.

### BRIEF DESCRIPTION OF THE DRAWINGS

The invention will be described with reference to the accompanying drawings, wherein like numbers reference like elements.

FIG. 1 is a diagram illustrating an image forming apparatus according to an embodiment of the invention.

FIG. 2 is a block diagram illustrating an electrical configuration of the image forming apparatus shown in FIG. 1.

FIG. 3 is a diagram illustrating appearance of a developer.

FIGS. 4A and 4B are a diagram illustrating a structure of the developer and a development bias waveform.

FIG. 5 is a partially enlarged diagram illustrating a developing roller and an enlarged part of a surface thereof.

FIG. 6 is a diagram illustrating an outline of the experiment performed by the inventors.

FIGS. 7A and 7B are results of evaluating a fogging amount and developing concentration according to a physical property value of the toner.

FIG. 8 is a view illustrating the measured results of a fogging amount when the regulation bias voltage is varied.

FIGS. 9A to 9D are model diagrams illustrating a behavior of the toner in a concave portion.

FIG. 10 is a model diagram microscopically illustrating the phenomenon shown in FIG. 9A to 9D.

FIGS. 11A to 11C are model diagram further microscopically illustrating the phenomenon shown in FIG. 10.

FIGS. 12A to 12C are diagrams a model in which the toner layer carried in the concave portion does not exceed one layer.

FIG. 13 is a diagram illustrating the effect resulting from application of the regulation bias voltage.

### DESCRIPTION OF EXEMPLARY EMBODIMENTS

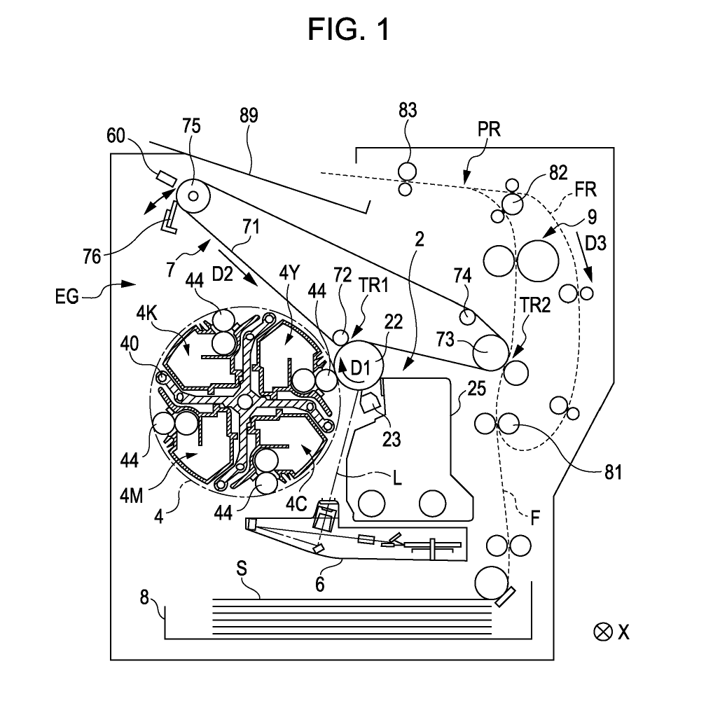

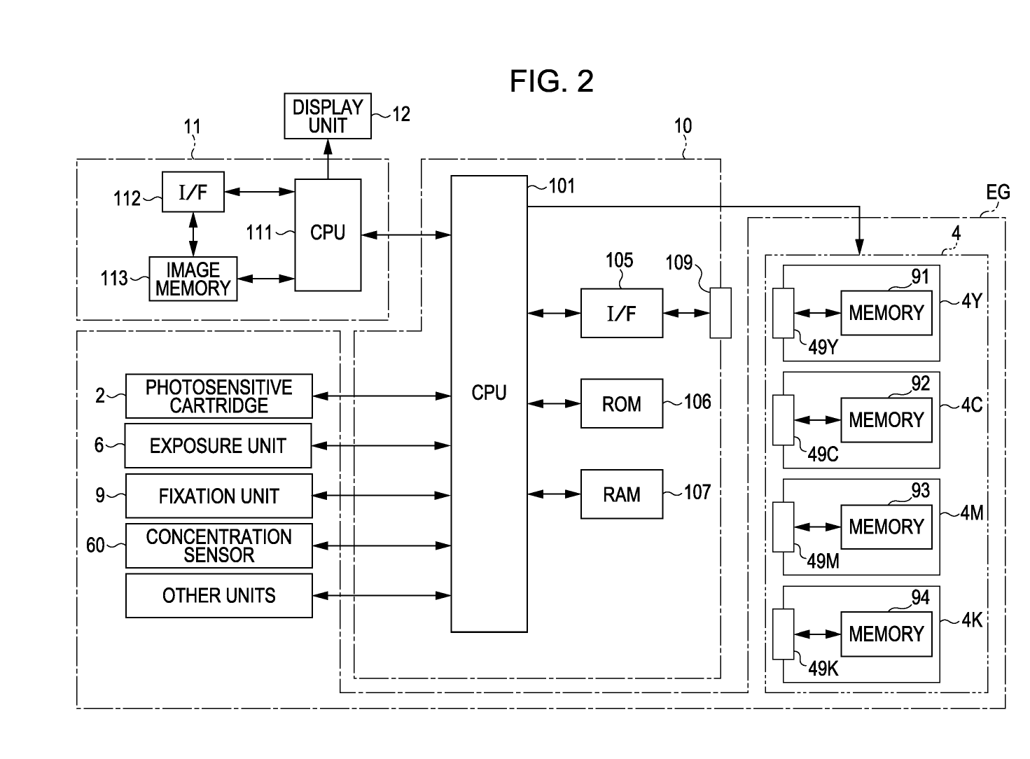

FIG. 1 is a diagram illustrating an image forming apparatus according to an embodiment of the invention. FIG. 2 is a block diagram illustrating an electrical configuration of the image forming apparatus shown in FIG. 1. This apparatus forms a full-color image by overlapping toner (developer) with 4 colors of yellow (Y), cyan (C), magenta (M), and black (K), or forms a monochromatic image using only black (K) toner. In the image forming apparatus, an image signal is transmitted from an external apparatus such as a host computer to a main controller 11, a CPU 101 provided in an engine controller 10 controls each unit of an engine unit EG in response to an instruction from the main controller 11 to perform a predetermined image forming operation, and forms an image corresponding to the image signal on a sheet S.

The engine unit EG is provided with a photoreceptor 22 rotatable in a direction indicated by an arrow D1 shown in FIG. 1. A charging unit 23, a rotary developing unit 4, and a cleaning portion 25 are disposed around the photoreceptor 22 along the rotation direction D1. A predetermined charging bias is applied to the charging unit 23, and the charging unit 23 uniformly charges an outer peripheral surface of the photoreceptor 22 to a predetermined surface potential. The cleaning portion 25 removes remaining toner attached to the surface of the photoreceptor 22 after a first transfer, and recovers the toner in a wasted toner tank provided therein. The photoreceptor 22, the charging unit 23, and the cleaning portion 25 integrally constitute a photoreceptor cartridge 2, and the photoreceptor cartridge 2 is integrally attachable to and detachable from an apparatus body.

A light beam L is irradiated from an exposure unit 6 to the outer peripheral surface of the photoreceptor 22 charged by the charging unit 23. The exposure unit 6 irradiates the light beam L onto the photoreceptor 22 in response to an image signal transmitted from the external apparatus, thereby forming an electrostatic latent image corresponding to the image signal.

The electrostatic latent image constructed as described above is developed with toner by the developing unit 4. That is, in this embodiment, the developing unit 4 is provided with a support frame 40 rotatable about a rotation axis perpendicular to a paper plane of FIG. 1, a yellow developer 4Y, a cyan developer 4C, a magenta developer 4M, and a black developer 4K, which contain each color toner, as cartridges attachable to and detachable from the support frame 40. The developing unit 4 is controlled by the engine controller 10. The developing unit 4 is rotated on the basis of a control instruction from the engine controller 10. If these developers 4Y, 4C, 4M, and 4K are selectively positioned at a predetermined development position opposite to the photoreceptor 22, a developing roller 44 provided at the corresponding developer and carrying the selected color toner is disposed opposite to the photoreceptor 22 with a predetermined gap, and the toner is applied from the developing roller 44 to the surface of the photoreceptor 22 at the opposite position. Accordingly, the electrostatic latent image formed on the photoreceptor 22 is developed with the selected toner color.

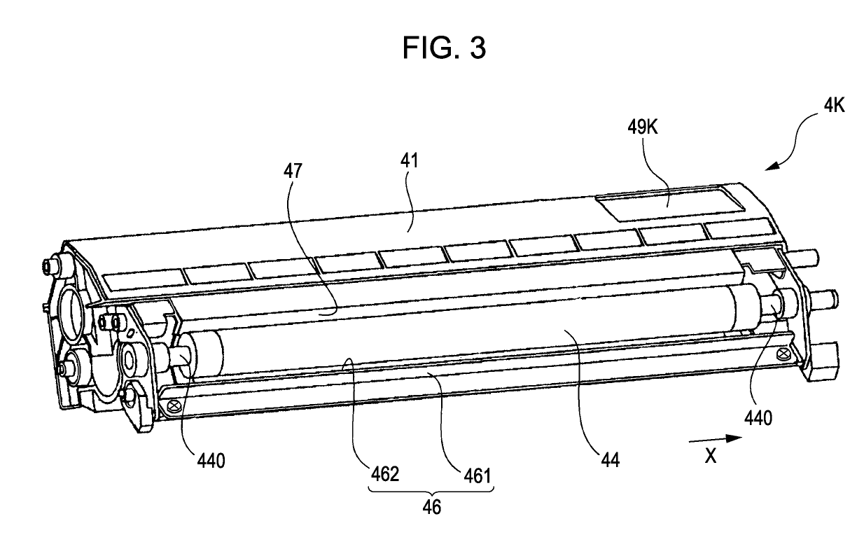

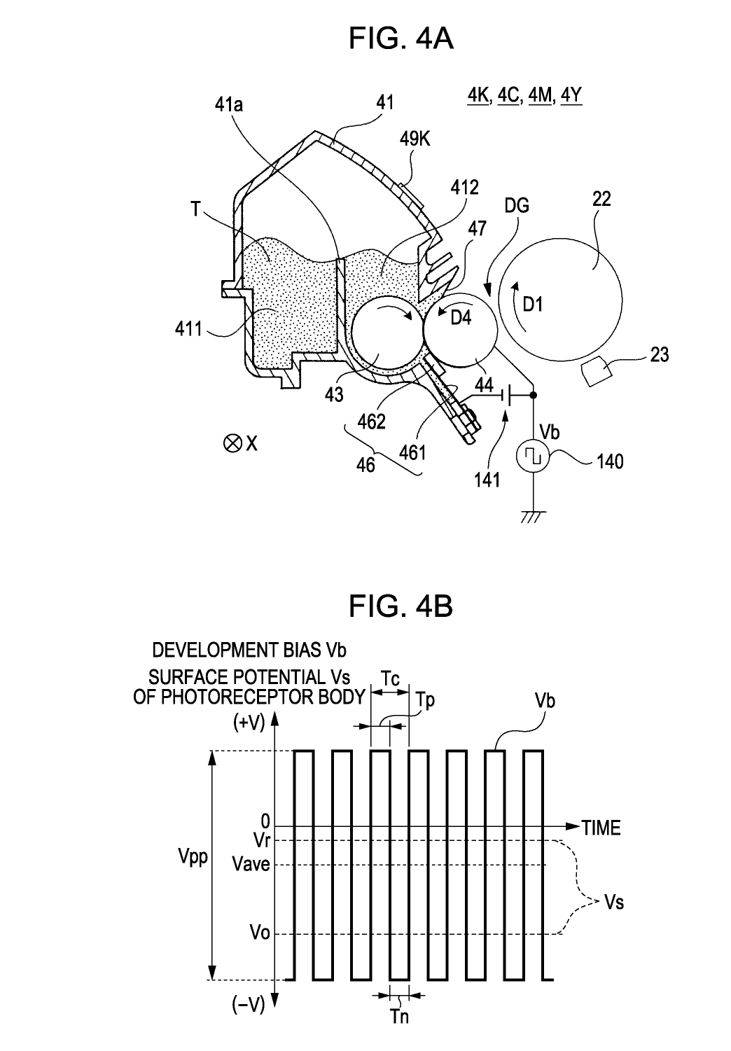

FIG. 3 is a diagram illustrating the appearance of the developer. FIGS. 4A and 4B are diagrams illustrating a structure of the developer and a developing bias waveform. More specifically, FIG. 4A is a cross-sectional view illustrating the structure of the developer, and FIG. 4B is a diagram illustrating a relationship between a development bias waveform and a photoreceptor surface potential. All the developers 4Y, 4C, 4M, and 4K have the same structure. Accordingly, a configuration of the developer 4K will be described in more detail with reference to FIG. 3 and FIG. 4A. Structures and functions of the developers 4Y, 4C, and 4M are the same as those of the developer 4K.

In the developer 4K, a feeding roller 43 and a developing roller 44 are rotatably provided by shafts in a housing 41 for containing nonmagnetic toner T therein. When the developer 4K is positioned at the development positions, the developing roller 44 is positioned at a position opposite to the photoreceptor 2 with a development gap DG, and the rollers 43 and 44 are engaged with a rotation driving portion (not shown) provided on the main body side and are rotated in a predetermined direction. The feeding roller 43 is formed of, for example, an elastic material such as foam urethane rubber and silicon rubber in a cylindrical shape. The developing roller 44 is formed of metal or alloy such as copper, aluminum, and stainless in a cylindrical shape. In this embodiment, the developing roller having a cylindrical metal surface which is subjected to electroless nickel/phosphor plating is used. The two rollers 43 and 44 are rotated in contact with each other and thus the surface of the developing roller 44 is coated with the toner, thereby forming a toner layer with a predetermined thickness on the surface of the developing roller 44. In this embodiment, negative-charged toner is used, but positive-charged toner may be used.

An inner space of the housing 41 is divided into a first chamber 411 and a second chamber 412 by a partition wall 41a. The feeding roller 43 and the developing roller 44 are provided in the second chamber 412. Toner stored in the second chamber 412 is fed to the surface of the developing roller 44 while the toner flows and mixes by rotation of the rollers 43 and 44. Toner stored in the first chamber 411 is isolated from the feeding roller 43 and the developing roller 44, and thus the rotation does not cause the toner to flow. When the developing unit 4 is rotated with the developer kept, the toner is mixed and stirred with the toner stored in the second chamber 412.

As described above, in the developer, the inside of the housing is divided into two chambers, the peripheries of the feeding roller 43 and the developing roller 44 are surrounded with the side wall of the housing 41 and the partition wall 41a, so that the second chamber 412 having a relatively small capacity is provided. Accordingly, even when the amount of remaining toner is decreased, the toner is efficiently fed to the vicinity of the developing roller 44. In addition, the toner is fed from the first chamber 411 to the second chamber 412 and the whole toner is stirred by the rotation of the developing unit 4. Accordingly, an augerless structure without a stirring member (auger) for stirring toner in the developer is realized.

The developer 4K is provided with a regulation blade 46 for restricting the thickness of the toner layer formed on the surface of the developing roller 44 to a predetermined thickness. The regulation blade 46 is formed of a plate member 461 having elasticity such as stainless or bronze, and an elastic member 462 made of a resin member, such as silicon rubber or urethane rubber, provided at a front end of the plate member 461. Conductive particles such as carbon particles are dispersed in the elastic member 462, and its resistivity is adjusted to about 10⁶ Ωcm. Further, its hardness is JIS-A hardness 70 degrees.

A rear end of the plate member 461 is fixed to the housing 41. The elastic member 462 provided at the front end of the plate member 461 is disposed on the more upstream side than the rear end of the plate member 461, in a rotation direction D4 of the developing roller 44 indicated by an arrow shown FIGS. 4A and 4B. That is, the regulation blade 46 is provided in such a way that its one end (rear end) is fixed and its free end, that is, a front end, opposite to the one end is attached toward the upstream side in the rotation direction D4 of the developing roller 44, and the elastic member 462 elastically comes into contact with the surface of the developing roller 44 in a so-called counter direction, thereby forming a restriction nip and thus finally restrict the toner layer formed on the surface of the developing roller 44 to a predetermined thickness. The contacting pressure (i.e., restriction load) of the regulation blade 46 against the surface of the developing roller 44 is adjusted to 5 gf/cm.

The toner layer formed on the surface of the developing roller 44 is sequentially transported to a position opposite to the photoreceptor 22 having the electrostatic latent image formed on the surface thereof by the rotation of the developing roller 44. A development bias is applied from a bias power supply 140 controlled by the engine controller 10, to the developing roller 44. As shown in FIG. 4B, after a surface potential Vs of the photoreceptor 22 is uniformly charged by the charging unit 23, the potential is decreased to approximately a rest potential Vr at the exposed portion to which the light beam L is irradiated from the exposure unit 6, and the potential becomes a substantially uniform potential Vo at a non-exposed portion to which the light beam L is not irradiated. A development bias Vb applied to the developing roller 44 is a square waveform alternating-current voltage overlapped with a direct-current potential, a peak-to-peak voltage is represented by Vpp. When the development bias Vb is applied as described above, the toner carried on the developing roller 44 flies in the development gap DG and is partially attached to each part of the surface of the photoreceptor 22 in response to the surface potential Vs, thereby developing the electrostatic latent image formed on the photoreceptor 22 into a toner image of the toner color.

For example, a square waveform voltage having a peak-to-peak voltage Vpp of 1500 V and a frequency of 3 to 4 kHz may be used as the development bias voltage Vb. If a waveform duty WD of the development bias Vb is defined by the following equation,

WD=Tp/(Tp+Tn)=Tp/Tc

whereby among a repetition period Tc of an alternating-current component of the development bias Vb, a period in which the potential is vibrated in a positive side is expressed by Tp, and a period in which the potential is vibrated in negative side is expressed by Tn, in this embodiment, in order to Tp>Tn, that is, the waveform duty WD becomes over 50%, the bias waveform is determined. Typically, it may be WD=60%.

A weighted average voltage Vave of the development bias Vb, of which a direct-current component resulted from the waveform duty is added to the direction-current component overlapped with the square waveform alternating-current voltage may be set to a value necessary for obtaining a predetermined image concentration since a potential difference from the rest potential Vr of the photoreceptor 22 becomes so-called contrast to have an influence on the image concentration. As a typical example, the weighted average voltage may be set to −200 V.

Although the detail will be described later, a regulation bias power source 141 is connected between the plate member 461 made of metal plate and the developing roller 44 which constitute the regulation blade 46, and a predetermined regulation bias voltage is applied to the conductive elastic member 462.

In addition, the housing 41 is provided with a seal member 47 in press contact with the surface of the developing roller 44 on the more downstream side than the position opposite to the photoreceptor 22 in the rotation direction of the developing roller 44. The seal member 47 is formed of a resin material having flexibility such as polyethylene, nylon, or fluorine resin, and is a band-shaped film extending along a direction X parallel to the rotation axis of the developing roller 44. One end of the seal member 47 in a short-hand direction (direction along the rotation direction of the developing roller 44) perpendicular to the length direction X is fixed to the housing 41, and the other end comes into contact with the surface of the developing roller 44. The other end comes into contact with the developing roller 44 toward the downstream side, in the rotation direction D4, of the developing roller 44, that is, in a so-called trail direction. The seal member 47 guides the toner remaining on the surface of the developing roller 44 passing through the position opposite to the photoreceptor 22 into the housing 41, and prevents the toner in the housing 41 from leaking out.

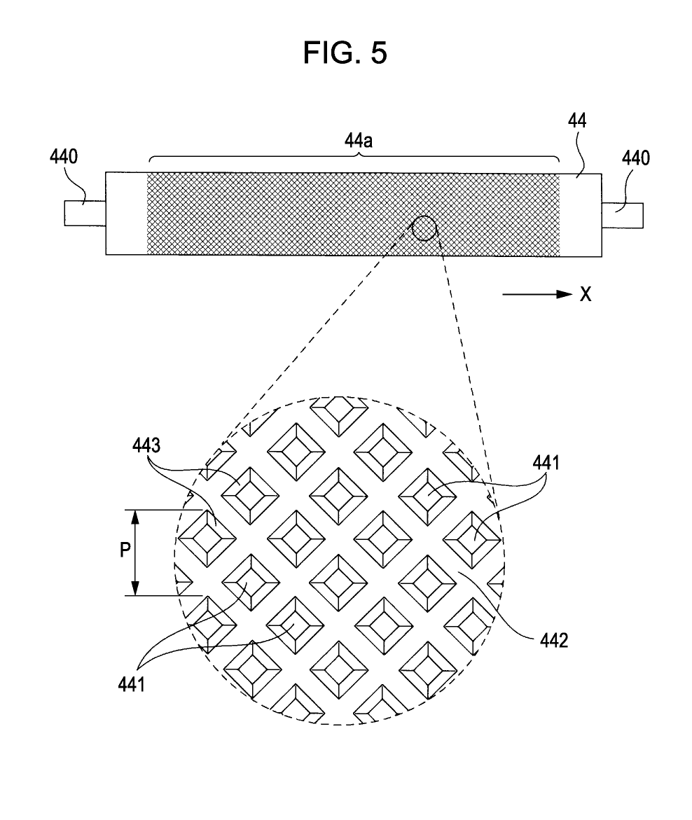

FIG. 5 is a diagram illustrating the developing roller 44 and an enlarged part of a surface thereof. The developing roller 44 has a substantially cylindrical roller shape, and a shaft 440 is provided at both ends of the developing roller in its longitudinal direction on the same axis as that of the developing roller 44. The shaft 440 is supported by the developer body, and thus the whole developing roller 44 is rotatable. A plurality of regularly arranged convex portions 441 and concave portions 442 surrounding the convex portions 441 are provided at a center portion 44a of the surface of the developing roller 44, as shown in the partially enlarged diagram (in dotted-line circle) of FIG. 5.

Each of the convex portions 441 protrudes toward the front of the paper plane of FIG. 5, and a top surface of each convex portion 441 constitutes a part of a single cylindrical surface having the same axis as the rotation axis of the developing roller 44. The concave portions 442 are formed of continuous grooves surrounding the convex portions 441 in a mesh shape, and the whole concave portions 442 has the same axis as the rotation axis of the developing roller 44 and forms one cylindrical surface different from the cylindrical surface formed by the convex portions. The convex portions 441 and the concave portions 442 enclosing the convex portions are connected to each other by gentle side surfaces 443. That is, normal lines of the side surfaces 443 have a component toward the outside, in a radial direction, of the developing roller 44 (upward in FIG. 5), that is, in a direction away from the rotation axis of the developing roller 44.

In this embodiment, an arrangement pitch P of the convex portions 441 on the surface of the developing roller 44 is 100 μm in a circumferential direction and an axial direction (direction X). The depth of the concave portion 442, that is, a difference in height of the convex portion 441 and the concave portion 442 is 20 μm. Further, a gap (developing gap) between the photoreceptor 22 and the developing roller 44 is set to 190 μm.

The developing roller 44 having such a configuration may be manufactured by the manufacturing method using a so-called thread rolling disclosed in, for example, JP-A-2007-140080. Consequently, the cylindrical surface of the developing roller 44 may be provided with regularly and uniformly concave/convex portions. For this reason, the obtained developing roller 44 can carry the uniform and optimum amount of toner on the cylindrical surface, and can equalize rolling motion (easiness of rotation) of the toner on the cylindrical surface of the developing roller 44. As a result, it is possible to prevent local charging defects or transport defects in the toner, and thus to exhibit the superior developing characteristics. In addition, as compared with a common developing roller obtained by blasting work so as to form the concave/convex portions using a mold, the obtained concave/convex portions can be have a convex portion with a leading end of a relatively large width. These concave/convex portions have the superior mechanical strength. In particular, since the mechanical strength of the portion pressed by the mold is increased, the obtained concave/convex portion has superior mechanical strength relative to concave/convex portions obtained by the processing such as cutting work. The developing roller 44 having the concave/convex portions can exhibit superior durability. Further, if the leading end of the convex portion of the concave/convex portions has the relatively large width, the shape variations due to wear are small, so that it is possible to prevent the developing characteristics from being dramatically deteriorated, thereby exhibiting the superior developing characteristics for a long time.

The image forming apparatus is described with reference to FIG. 1 again. The toner image developed by the developing unit 4 as described above is transferred onto an intermediate transfer belt 71 of a transfer unit 7 in a first transfer region TR1. The transfer unit 7 is provided with the intermediate transfer belt 71 suspended to a plurality of rollers 72 to 75 and a driving portion (not shown) for rotating the intermediate transfer belt 71 in a predetermined rotation direction D2 by rotating the roller 73. In a case where a color image is transferred to the sheet S, toner images of colors formed on the photoreceptor 22 are overlapped with each other on the intermediate transfer belt 71 to form a color image, and the color image is secondarily transferred to the sheet S taken from a cassette 8 one by one and transported to a second transfer region TR2 along a transport path F.

In this instance, in order to accurately transfer the image on the intermediate transfer belt 71 to a predetermined position on the sheet S, the time to transport the sheet S to the second transfer region TR2 is managed. Specifically, a gate roller 81 is provided on the just front side of the second transfer region TR2 on the transport path F, and the gate roller 81 is rotated according to the time of circulating the intermediate transfer belt 71, thereby transporting the sheet S to the second transfer region TR2 at a predetermined time.

The toner image is fixed on the sheet S, on which the color image is formed, by a fixing unit 9, and the sheet S is transported to a discharge tray 89 provided at an upper part of the apparatus body through a before-discharge roller 82 and a discharge roller 83. In case of forming images on both surface of the sheet S, the rotation direction of the discharge roller 83 is reversed at the time when the trailing end of the sheet S having an image formed on one surface thereof as described above is transported to a reverse portion PR of the rear of the before-discharge roller 82, thereby transporting the sheet S in a direction indicated by an arrow D3 along a reverse transport path FR. The sheet S is loaded on a transport path F again just before the gate roller 81. At this time, the surface of the sheet S on which the image is transferred and which is in contact with the intermediate transfer belt 71 in the second transfer region TR2 is a surface opposite to the surface on which the image is previously transferred. As described above, it is possible to form images on both surfaces of the sheet S.

As shown in FIG. 2, each of the developers 4Y, 4C, 4M, and 4K is provided with memories 91 to 94 for storing data about the product lot and use history of the developer, an remaining amount of the stored toner, and the like. The developers 4Y, 4C, 4M, and 4K are provided with radio communicator 49Y, 49C, 49M, and 49K, respectively. As necessary, they perform non-contact data communication with a radio communicator 109 provided on the main body side selectively, and the data is transmitted and received between the CPU 101 and the memories 91 to 94 through an interface 105, thereby managing various kinds of information about the developer, such as management consumables. In this embodiment, the non-contact data transmission and reception are performed using electromagnetic means such as radio communication. However, the main body and developers may be provided with connectors, and the data transmission and reception may be performed by mechanically connecting the connectors to each other.

As shown in FIG. 2, the apparatus is provided with a display unit 12 controlled by the CPU 111 of the main controller 11. The display unit 12 is formed of, for example, a liquid crystal display, and displays a predetermined message such as an operation guide, a progress of an image forming operation, an error of the apparatus, and time to exchange some units to a user, in response to a control instruction from the CPU 111.

In FIG. 2, reference numeral 113 denotes an image memory provided at the main controller 11 to store an image transmitted from an external apparatus such as a host computer through an interface 112. Reference numeral 106 denotes a ROM for storing control data for controlling an operation program or the engine unit EG executed by the CPU 101, and reference numeral 107 denotes a RAM for temporarily storing an operation result or the other data in the CPU 101.

A cleaner 76 is provided in the vicinity of a roller 75. The cleaner 76 can be closed to and separated from the roller 75 by an electric clutch (not shown). In a state where the cleaner 76 is moved close to the roller 75, a blade of the cleaner 76 comes into contact with the surface of the intermediate transfer belt 71 suspended on the roller 75 and removes remaining toner attached to the outer peripheral surface of the intermediate transfer belt 71 after the second transfer.

A concentration sensor 60 is provided in the vicinity of the roller 75. The concentration sensor 60 is opposite to the surface of the intermediate transfer belt 71, and measures image concentration of the toner image formed on the outer peripheral surface of the intermediate transfer belt 71 as necessary. In the apparatus, based on the measured result, operation conditions of each unit having an influence on image quality are controlled, for example, a development bias applied to the developer, an intensity of the exposure light beam L, a tone correction characteristic of the apparatus, and the like.

The concentration sensor 60 is configured to output a signal corresponding to light and shade of a predetermined area on the intermediate transfer belt 71 by using, for example, a reflective photo sensor. The CPU 101 circumferentially circulates the intermediate transfer belt 71 and periodically performs sampling of the signal output from the concentration sensor 60, thereby detecting image concentration of each portion of the toner image on the intermediate transfer belt 71.

Next, the toner used in this embodiment will be described. The toner is a nonmagnetic one-component toner fabricated by a known grinding method, and has negative charge due to frictional charge. The toner has a volume average grain size (hereinafter, expressed by code Dave) of 8 μm, and contains two kinds of silica of 1.0 wt % and 0.5 wt % as an external additive, each having a volume average grain size of 12 nm and 50 nm. Further, as an external additive of metal oxide for adjusting charge amount, 1.0 wt % titanium oxide (titania) having a volume average grain size of 30 nm is contained. The reason why the toner has this composition will be described later. In this instance, in the below description, unless it is especially described, physical properties of the toner used in experiments are equal to the above.

Several techniques for improving the charging characteristics of the toner on the developing toner by applying the bias to the regulation blade have been proposed, and there are, for example, JP-A-2006-220967 and JP-A-58-153972, in addition to JP-A-2005-331780. In these documents, in addition to application of the bias to the regulation blade, it is described in that it is effective that the toner charge amount is improved by appropriately adjusting the conductivity of the toner particles. However, according to various experiments of the inventors, findings were obtained different from the description.

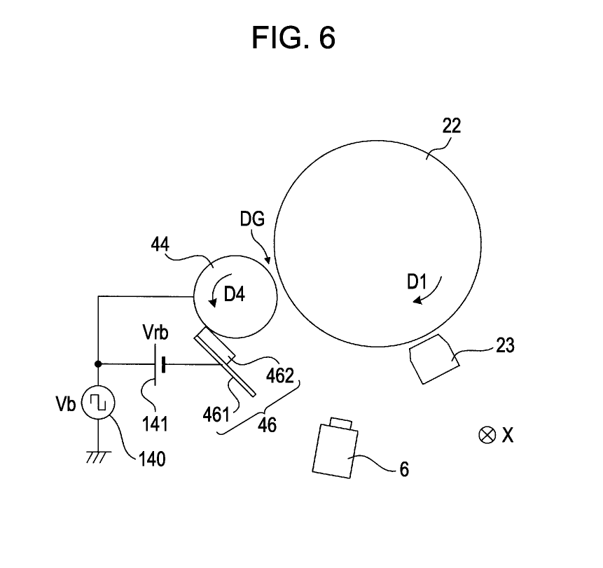

FIG. 6 is a diagram illustrating an outline of the experiment performed by the inventors. In this experiment, the photoreceptor 22 is rotated in the rotation direction D1 and is charged to a predetermined surface potential by the charging unit 23, and in a state in which the exposure by the exposure unit 6 is not performed, the developing bias Vb is applied to the developing roller 44. In this instance, the developing roller 44 and the regulation blade 46 are electrically connected to each other by the regulation bias power source 141 to apply the regulation bias voltage Vrb to the regulation blade 46. In this state, the developing characteristic was evaluated by variously changing the regulation bias voltage Vrb, or the composition or physical property value of the toner.

First, on the surface of the developing roller 44, in the case in which a toner layer exceeding one layer is carried in the convex portion 441 or a toner layer exceeding two layers is carried in the convex portion 442, scattering or fogging occurrence of the toner from the developing roller 44 is significant, irrespective of other conditions. Therefore, in the experiment below, by restricting the carriage of the toner in the convex portion 441 by a so-called edge restriction in which an upstream edge portion of the elastic member 462 of the regulation blade 46 comes into contact with the convex portion 441 of the surface of the developing roller 44 and setting a difference in height between the convex portion 441 and the concave portion 442 to a values which exceeds one time as large as the volume average grain size of the toner and does not exceed two times as large as the volume average grain size, the toner layer in the concave portion 442 was set to be about 1 to 1.5 layer. For this purpose, in the developing roller 44 used in the experiment, the height difference between the convex portion 441 and the concave portion 442 was 15 μm (≈1.88 Dave).

If the toner layer on the developing roller exceeds one layer, the toner (contact toner) which is carried in direct contact with the surface of the developing roller and the toner (non-contact toner) which is not in direct contact with the surface of the developing roller and carried on the contact toner over the surface are mixed in the toner layer. While it will be described later, due to the difference in the adhesion force to the developing roller, the contact toner is hard to separate from the surface of the developing roller, and the non-contact toner is easy to separate from the surface. In this regard, it is preferable that the toner layer is constituted of the contact toner only in point of the scattering and fogging prevention, but it is preferable that the toner layer contains the non-contact toner which is easy to separate, in point of acquisition of sufficient developing concentration. Ideally, the toner layer containing both the contact toner and the non-contact toner is carried and measures are taken to prevent the scattering and fogging.

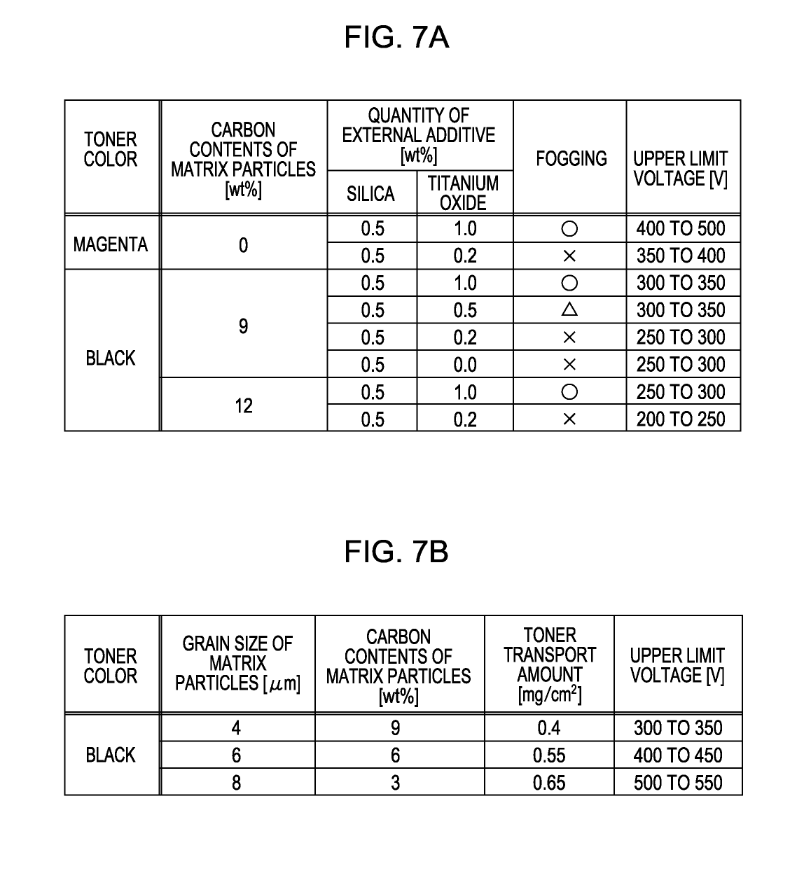

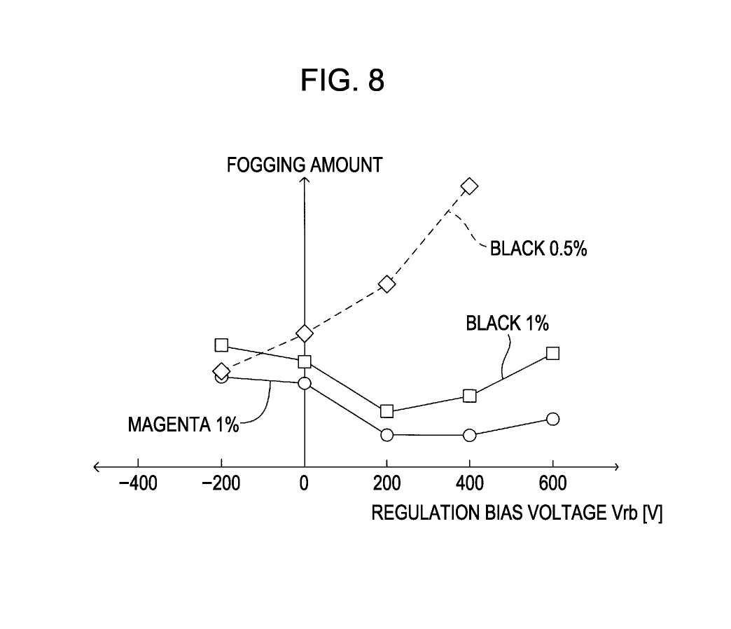

FIGS. 7 and 8 are diagrams illustrating a part of the experiment results. The respective experiment contents and its result are described in detail. FIG. 7A is results of evaluating amount of fogging and developing concentration in the photoreceptor 22 when the regulation bias voltage Vrb of 200 to 500 V is applied, contents of the carbon black in the toner matrix particles are varied, and the contents of the titanium oxide as the external additive is varied. Here, the magenta toner having a volume average grain size of 8 μm and two kinds of black toners having different carbon contents were used. The carbon black is added to the black toner matrix particles as black pigment. However, since the carbon black has conductivity, in point of fact the higher the content, the higher conductivity, the carbon black has a function of controlling the conductivity of the toner. Of course, the carbon black is not contained in the magenta toner. Consequently, the three kinds of toner have matrix particles of different conductivities.

If the amount of the silica having a grain size of 50 nm as the external additive is fixed (0.5 wt %) and the contents of the titanium oxide are thus varied, in the figure, “O” indicates that a fogging amount is small, “X” indicates that the fogging amount is large, and “Δ” indicates that the fogging amount is intermediate. According to the results, irrespective of the carbon contents of the toner matrix particles, as the contents of the titanium oxide as the external additive increases, the amount of fogging is decreased. More specifically, when the contents of the titanium oxide are larger than that of the silica, fogging is low. In order to obtain a sufficient fogging suppression effect, it is necessary for the titanium oxide to be at least 0.5 wt % which is similar to the contents of the silica.

Although not described herein, if the amount of the silica as the external additive was varied, there was little difference in the results of the experiment. However, if the amount of the silica is larger than that of the titanium oxide, in particular, the large grain size component is increased, a fogging reducing effect is hardly obtained by increasing or reducing the amount of the titanium oxide.

Meanwhile, the developing concentration is evaluated by the following way. As shown in FIG. 6, the polarity of the regulation bias voltage Vrb is defined in such a way that the regulation blade 46 is set to a low potential with respect to the developing roller 44. Consequently, at the value (200 to 500 V) of the regulation bias voltage Vrb in the experiment, the regulation blade 46 side is applied with a negative potential rather than the developing roller 44. By the negative voltage applied to the regulation blade 46, the charge amount of the toner is increased, and an electric field facing the developing roller 44 from the regulation blade 46 is formed. Therefore, the negatively charged toner is pulled toward the developing roller 44 side, so that the developing ability is decreased and the developing concentration is deteriorated. Further, if the voltage applied to the regulation blade 46 is excessively large, electric current flows in the toner particles or on the surface of the toner, charge charges are disturbed, thereby creating the transport defects and thus causing concentration unevenness in the image. Therefore, the value of the regulation bias voltage Vrb in which the transport defect starts to happen is described as an “upper limit voltage”. If the amount of the titanium oxide as the external additive is small, the upper limit voltage is lowered. So, it means that a range taken by the regulation bias voltage Vrb is narrowed, so that the degree of freedom in designing is lowered.

FIG. 7B is results of comparing the toner transport amount with the upper limit voltage on the surface of the developing roller 44 with respect to the black toner having different grain sizes. It seems that since the toner layers are formed in one or 1.5 toner layers in the concave portion 442, the difference between the toners mainly depends upon the contents of the carbon black of the matrix particles. Although coinciding with the results shown FIG. 7A, the upper limit voltage is lowered in the toner having high carbon content. Further, under the conditions in which the upper limit voltage is low, reliable improvement of the charge amount of the toner on the surface of the developing roller 44 is not seen. It seems that if the conductivity of the toner matrix particles is high, the leak current flows between the developing roller 44 and the regulation blade 46 via the toner, and thus the charge amount of the toner is disturbed.

In the configuration of applying the bias voltage to the regulation blade to control the charge amount of the toner on the surface of the developing roller, there is a case in which the increase of the conductivity of the toner does not yield desirable results, but produces a contrary result. That is, a model in which “the charge amount is improved by applying charges to the conductive toner” was not verified in this experiment.

FIG. 8 is a view illustrating the measured results of the fogging amount when the regulation bias voltage is varied. The magenta toner containing 1 wt % titanium oxide, and black toners of two kinds each containing titanium oxide of 1 wt % and 0.5 wt % were used as the toner. As a result, when a proper positive voltage (viewed from the regulation blade 46, a negative voltage like the charge polarity of the toner) was applied as the regulation bias voltage Vrb, the fogging amount was minimized in any one of the magenta toner and the black toner, of which the titanium oxide was 1 wt %. In this way, if the negative voltage is applied to the regulation blade 46, the fogging amount was increased in the toner, of which the contents of the titanium oxide are small, while in the case in which an charge polarity of the toner and a voltage of reverse polarity are applied to the regulation blade 46, the fogging amount is lower. In addition, in the case the contents of the titanium oxide was identical, the fogging amount was low in the magenta toner having lower carbon contents and low conductivity than the black toner.

From the above, in order to reduce scattering or fogging by improving the charge amount of the toner, it is effective to control not the conductivity of the toner, but the contents of the titanium oxide serving as the external additive. More specifically, it is preferable that an appropriate amount of the titanium oxide is added to the toner as the external additive, and an appropriate regulation bias voltage of the same polarity as the charge polarity of the toner is applied to the regulation blade 46.

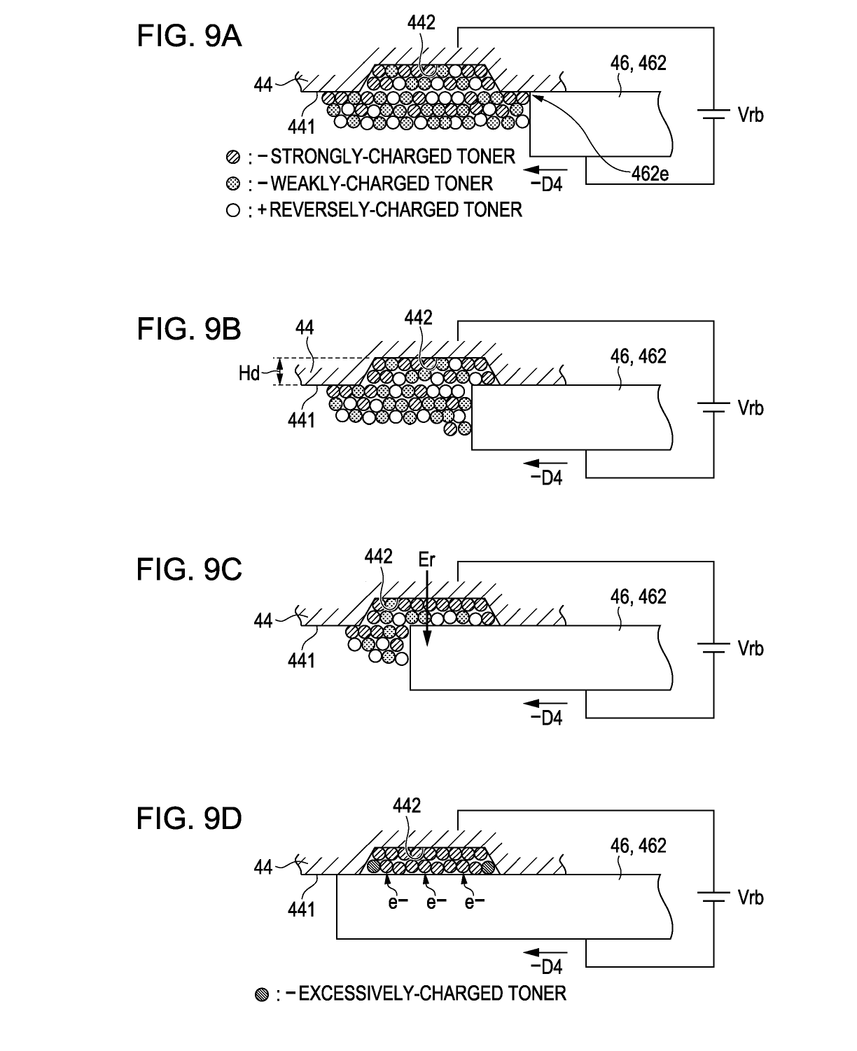

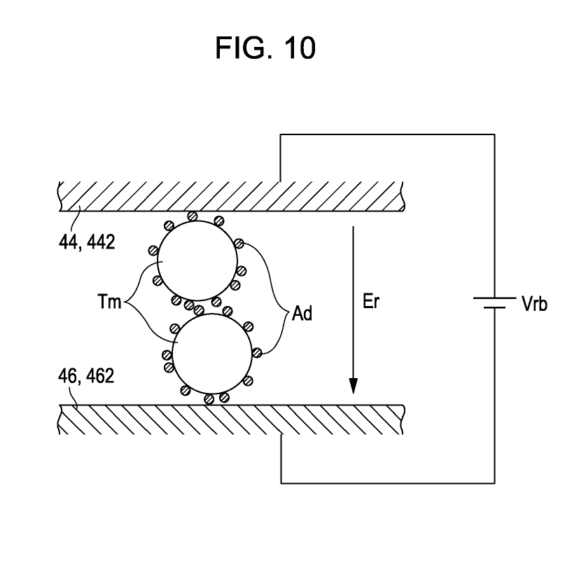

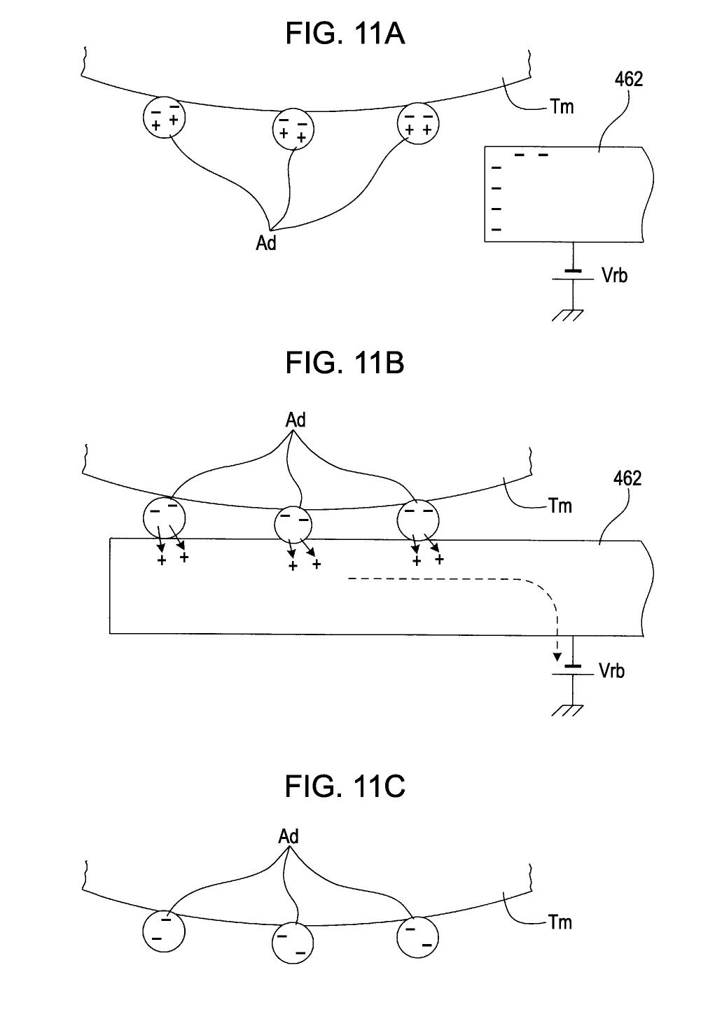

FIG. 9A to FIG. 11C are diagrams illustrating models of a mechanism for improving the charge amount of the toner in this embodiment. More specifically, FIG. 9A to 9D are model diagrams illustrating a behavior of the toner in the concave portion. FIG. 10 is a model diagram microscopically illustrating the phenomenon shown in FIG. 9A to 9D. FIG. 11A to 11C are model diagrams further microscopically illustrating the phenomenon shown in FIG. 10. Here, this model is referred as “rearrangement/induced charging model”.

Since there are charging variations, the toner includes toner having a high charge amount, toner having a low charge amount, positively charged toner which is counter to original charge polarity (negative polarity), and the like. For convenience, the toner having the relatively high charge amount among the negatively charged toner which is the original charge polarity is hereinafter referred to as “strongly charged toner”, the toner having the low charge amount is referred to as “weakly charged toner”, the toner charged with a reverse polarity (i.e., the positive polarity) is referred to as “reversely charged toner”. Further, the toner having very high charge polarity particularly among the strongly charged toner is referred to as “an excessively charged toner”.

As shown in FIG. 9A, before layer restriction is performed by the regulation blade 46, toner particles having various charge amounts are distributed on the surface of the developing roller 44. Among them, the strongly charged toner having relatively high charge amount is strongly pulled toward the metal surface of the developing roller 44 by action of an image force. For this reason, a lot of strongly charged toner is placed at a position adjacent to the surface of the developing roller 44, and a lot of weakly charged toner or reversely charged toner is pushed by the strongly charged toner and is thus placed at a position away from the surface of the developing roller 44.

Since the developing roller 44 is rotated in the rotational direction D4, the regulation blade 46 (more specifically, the elastic member 462 constituting the regulation blade 46) is relatively moved in a (−D4) direction. In this embodiment, since the edge restriction, in which an edge portion 462e (corresponding to the upstream-most side in the rotation direction D4 of the developing roller 44) of the elastic member 462 which comes into contact the convex portion 441, is performed in the rotational direction D4 of the developing roller 44, as shown in FIG. 9B, as the regulation blade 46 proceeds in the (−D4) direction, the toner is removed from the convex portion 441. Further, in the concave portion 442, the toner having a thickness exceeding the thickness corresponding to a height difference Hd between the convex portion 441 and the concave portion 442 is scraped out and is also removed. In this experiment, since the height difference Hd between the convex portion 441 and the concave portion 442 is 15 μm in case of the toner having the volume average grain size of 8 μm, the toner layer of the concave portion 442 has a thickness thicker than one layer and thinner than two layers.

In this instance, if regulation bias voltage Vrb is applied between the developing roller 44 and the regulation blade 46, as shown in FIG. 9C, an electric field (hereinafter referred to as “restriction electric field”) Er facing the regulation blade 46 from the developing roller 44 is formed in the concave portion 442. The restriction electric field Er generates a force in a direction to push the negatively charged toner toward the surface side of the developing roller 44. Since the force forcibly acts by the toner having high charge polarity, the strong force pushing the toner toward the surface of the developing roller 44 acts on the strongly charged toner. By contrast, since the weaker force or the reverse force acts on the weakly charged toner having lower charge amount or the reversely charged toner, as a consequence, the strongly charged toner is collected at the position adjacent to the surface of the developing roller 44, while the weakly charged toner or the reversely charged toner is moved in a direction to deviate from the surface of the developing roller 44. As a result, the toner is rearranged in the concave portion 442. As the charge amount of the toner is higher, the toner is carried at the position adjacent to the surface of the developing roller 44. As the charge amount is lower or the toner is charged by the reverse polarity, the toner is carried at a position away from the surface of the developing roller 44.

In this experiment, since the toner layer of the concave portion 442 is less than two layers, as shown in FIG. 9C, the weakly charged toner or the reversely charged toner carried at the position away from the developing roller 44 comes in contact with the regulation blade 46. In this instance, as shown in FIG. 9D, since the negative charges (indicated by a symbol “e⁻”) are imparted in the toner from the regulation blade 46 applied with the regulation bias voltage Vrb (negative voltage with respect to the developing roller 44), the charge amount of the weakly charged toner or the reversely charged toner, of which the charge amount is insufficient, is increased. In this instance, it is conceivable that a portion of the toner carried in contact with the developing roller 44 comes in contact with the regulation blade 46. There is a case in which the toner becomes the excessively charged toner as its charge amount is further increased. The excessively charged toner is difficult to separate from the surface of the developing roller 44 due to the high charge amount. Therefore, if the amount of excessively charged toner is excessive, the developable property deteriorates which causes the concentration to decrease, but it is not problematic for scattering and fogging suppression.

The mechanism of imparting the charges by contacting the toner with the regulation blade 46 will be described in detail with reference to FIGS. 10 and 11. As shown in FIG. 10, the toner particles are in a state in which fine external additives Ad are dispersed around matrix particles Tm. The toner particles are filled between the concave portion 442 of the developing roller 44 and the elastic member 462 of the regulation blade 46, and a restriction electric field Er is formed therebetween by the regulation bias voltage Vrb. Basically, the toner contacting with the surface (the concave portion 442) of the developing roller 44 is not in contact with the regulation blade 46 (the elastic member 462), but the toner contacting with the regulation blade 46 is not in contact with the developing roller 44.

In the case in which the toner matrix particles Tm and the external additives Ad have sufficient conductivity, a leak current flows through the particles. It seems that mere passing of the current through the toner particle does not contribute to charging of the toner. However, there is a possibility in that the charge charges are scattered outwardly, so the charge amount is dissipated. If the conductivity of the toner matrix particles Tm is low, the external additive Ad has to have the conductivity and densely cover the whole surface of the matrix particle Tm, there is little leak current flows. The toner matrix particle having no conductivity will be considered herein.

It is understood that differently from the silica having a high insulation property used as the external additive, the titanium oxide or other metal oxide used as the external additive Ad shows a little conductivity (about 10⁷ to 10⁸ Ωcm) in a particle state. The toner of this embodiment is formed so that the surface of the matrix particle Tm is sparsely covered by the external additive Ad by adding an appropriate amount of an external additive having such a property.

In the toner which is not in contact with the developing roller 44, a phenomenon occurs in which the regulation blade 46 gradually approaches by the rotation of the developing roller 44, is in contact with the toner, and then is away from the toner. In the process, as the elastic member 462 provided with the negative bias Vrb approaches, as shown in FIG. 11A, positive charges are pulled near the elastic member 462 side by electrostatic induction in the external additive Ad of the surface of the toner matrix particles Tm. In this instance, if the external additive Ad comes in contact with the elastic member 462, as shown in FIG. 11B, the positive charges move toward the elastic member 462. This is equivalent to the state in which negative charges are imparted into the external additive Ad from the elastic member 462. Finally, if the elastic member 462 is spaced apart from the external additive, the external additive Ad is in a state in which the negative charges are excessive, as shown in FIG. 11C. As a result, it seems that the charges of the external additive Ad are added to the charge charges which are originally provided in the toner matrix particles Tm, by the friction charge, so that the charge amount of the whole toner particles is increased.

According to the rearrangement/induction charge model, the previous experimental results will be described well. That is, irrespective of the conductivity of the toner matrix particle Tm, if the titanium oxide of appropriate amount is added as the external additive Ad and the bias having the same polarity as the charge polarity of the toner is applied to the regulation blade 46, the charge amount of the toner is improved to suppress fogging. It seems that the external additive of titanium oxide receives negative charges from the regulation blade 46, so that the whole charge amount of the toner particles is improved. Further, the results are shown in which in the toner having low carbon contents, that is, low conductivity, fogging is low and the upper limit voltage to obtain the developing concentration is high (e.g., FIG. 8). However, it seems that if the conductivity of the toner matrix particles is increased, the charge imparted into the external additive leaks toward the matrix particle side, the external additive does not maintain the charges (i.e., does not maintain the charges across all toner particles.

Further, an influence of the silica as the insulating external additive will be conceived as follows. The insulating external additive hinders the application of the charges to the external additive of titanium oxide from the regulation blade 46. In particular, if its grain size is large or proportion is high, the influence is significant. As experimental results, when the amount of the titanium oxide is increased rather than that of the external additive of silica having large grain size, the charge property is improved. It would be understood from the above description that the external additive can receive the charges from the regulation blade 46 more reliably by increasing the amount of the titanium oxide more than the insulating external additive, thereby improving its charge property.

In addition, when the toner layer carried in the concave portion 442 was larger than one layer and less than two layers, the results in which both fogging and developing concentration were appropriate were obtained. It seems that according to the process of the rearrangement/induction charge of the toner in the concave portion 442, the originally and strongly charged toner having high charge amount is not influenced, but the charges can be selectively imparted into the weakly charged toner or the reversely charged toner only, so that the variation in the amount of charge is reduced. The effect of suppressing the charge variation is obtained by the configuration in which the surface of the developing roller 44 is provided with regular concave/convex portions to manage the height difference between the concave portion and the convex portion and carry the toner in the concave portions only.

In fact, it was observed that if the carried toner layer is excessively thick, scattering or fogging was increased. It seems that the amount of the weakly charged toner or reversely charged toner to which the charge has to be imparted is excessively increased, so that the toner for which the insufficient charge amount is not fully replenished is increased. In particular, since in the toner layer largely exceeds two layers, there is toner which is not in contact with any of the developing roller 44 and the regulation blade 46, so the toner, which cannot increase the charge amount, appears in the above-described rearrangement/induce charge model. In contrast, if the toner layer becomes thin, fogging is acceptable, but the developing concentration is dramatically decreased. It seems that not only the transport amount of the toner is small, but the toner having high charge amount is further applied by charging, adhesion of the toner to the developing roller 44 becomes strong, so that it is difficult to transfer the toner to the photoreceptor 22.

As described above, the height difference Hd between the convex portion and the concave portion is 20 μm in this embodiment, which is 2.5 times of the volume average grain size Dave (8 μm) of the toner. As a result, since the toner exceeding two layers is carried in the concave portion 442, it may cause trouble in the scattering. However, in this embodiment, since the outermost surface layer of the toner layer carried in the concave portion 442 is in contact with the regulation blade 46, its charge amount is increased, and thus it has a role of suppressing the scattering of the toner having a low charge amount in the inner layer. Consequently, it is possible to improve the developing concentration by increasing the transport amount of the toner, while preventing scattering. In this instance, if the toner exceeds three layers, one or more toner layer having a low charge amount is interposed between the layer in contact with the developing roller 44 and the surface layer, the scattering is increased.

By contrast, in a case in which the height difference Hd between the convex portion 441 and the concave portion 442 is equal to the volume average grain size Dave of the toner or the elastic member 462 is deeply bent into the concave portion 442 due to the low hardness of the elastic member 462 of the regulation blade 46 or a high restriction load, the toner layer carried in the concave portion 442 does not exceed one layer, a problem may arise, in which the toner is excessively charged.

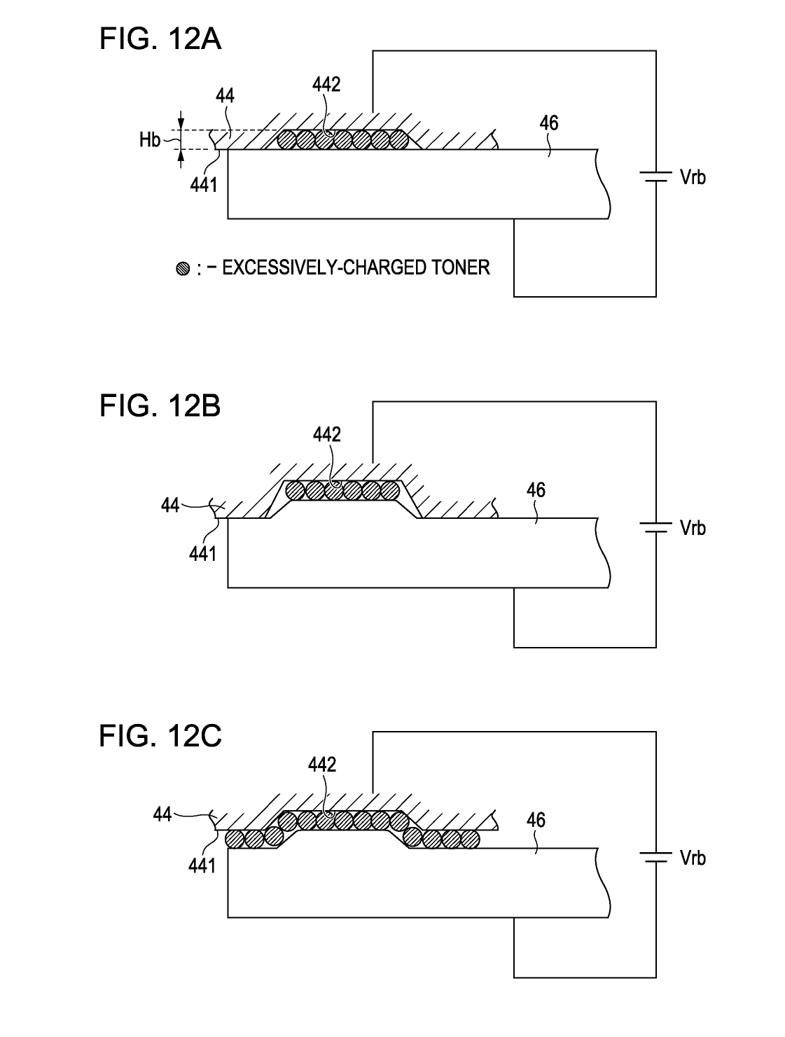

FIGS. 12A to 12C are diagrams illustrating a model in which the toner layer carried in the concave portion does not exceed one layer. As shown in FIG. 12A, in a case in which the height difference Hd between the convex portion 441 and the concave portion 442 is equal to the volume average grain size Dave of the toner, the contact toner directly contacting with the developing roller 44 is in contact with the elastic blade 462 applied with the regulation bias voltage Vrb. As a result, the charge is further imparted into the contact toner originally with high charge amount, and the toner is excessively charged. Therefore, it is difficult to separate the toner from the developing roller 44, thereby causing a decrease in the developing concentration.

As shown in FIG. 12B, the same situation occurs in the case in which the height difference Hd between the convex portion 441 and the concave portion 442 is larger than the volume average grain size Dave of the toner, and the surface of the elastic member 462 is largely bent into the bottom of the concave portion 442. Also, as shown in FIG. 12C, in a case in which the toner without exceeding one layer is carried on the convex portion 441, most of the toner on the convex portion 441 is excessively charged.

In the above description, in this embodiment, the toner carried by the convex portion 441 is restricted by contacting the developing roller 44 with the elastic member 462 made of conductive rubber with at least JIS-A hardness 70 degrees under a relatively low restriction load of 5 gf/cm. Further, the height difference Hd between the convex portion 441 and the concave portion 442 is set to 20 μm which is 2.5 times as much as the volume average grain size Dave (8 μm) of the toner, so that the toner layer of 2.5 layers is carried in the concave portion 442, thereby suppressing the decrease in the transport amount of the toner by restricting the toner to be carried on the convex portion 441 and thus the deterioration in the developing concentration. Further, in order to prevent the non-contact toner, which necessarily results from the toner layer of the concave portion 442 exceeding one layer, from causing scattering or fogging, it was configured to apply negative regulation bias voltage Vrb which is equal to the charge polarity of the toner, to the elastic member 462.

With the above configuration, in this embodiment, the variation in the charge amount of the toner carried on the surface of the developing roller 44 is suppressed, and the charge amount of the toner having low charge amount is increased while suppressing the toner originally with high charge amount from being excessively charged, so that it is possible to prevent scattering or fogging of the toner from occurring from the developing roller 44 and secure the sufficient developing concentration, thereby forming the image of appropriate quality.

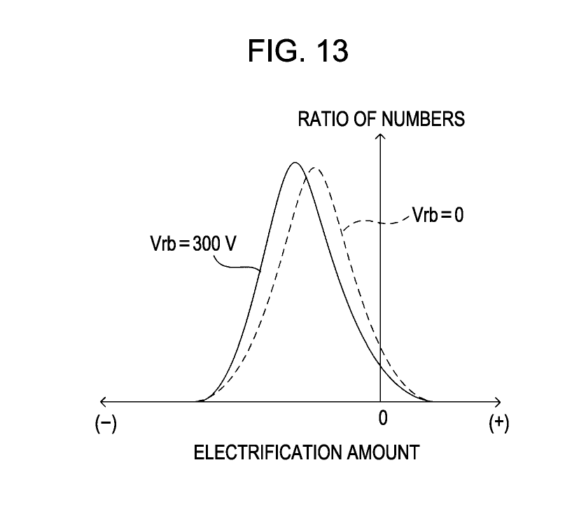

FIG. 13 is a diagram illustrating the effect resulting from application of the regulation bias voltage. More specifically, the figure illustrates one example of respectively measuring the distribution of the charge amount of the toner on the surface of the developing roller 44 after the developing roller passes through the restriction nip contacting with the regulation blade 46 in the cases in which the regulation bias voltage Vrb is applied to the regulation blade 46 or not. Here, a set value of the regulation bias voltage Vrb was 300 V, at which the best results were obtained in point of the effect of suppressing fogging in the above experiments. Comparing with the distribution of the charge amount in the case, indicated by a dotted line, in which the regulation bias voltage 0 is applied, that is, the regulation blade 46 and the developing roller 44 are applied with the same potential, a peak of the distribution is shifted toward a negative polarity in the case, indicated by a solid line, in which the regulation bias voltage Vrb is applied. However, a result in which a lower portion of the distribution was not so changed was obtained. It shows that the object of the invention which imparts the charges preferentially to the toner having a low charge amount is achieved. If the charge is also imparted into the toner having a high charge amount, the lower portion of the negative polarity side will be enlarged in a negative polarity side (a left direction in the figure), but such a phenomenon is not seen.

In this instance, as shown in FIG. 8, even though the regulation bias voltage Vrb is too high or too low, the effect of suppressing fogging is lowered. In the case in which the regulation bias voltage Vrb is too high, insulation breakdown of the toner occurs, or a leak current flows through the conductive external additive. Consequently, it seems that the dissipation of the charges of the toner causes fogging to increase. In the experimental result shown in FIGS. 7A and 7B, the reduction of the upper limit voltage is shown in the toner having a high content of the carbon black or the toner of small grain size. Further, it seems that the reason why fogging is increased when the regulation bias voltage Vrb is low is that the effect of imparting the charges from the regulation blade 46 is not sufficient. In this regard, it is preferable that the size of the regulation bias voltage Vrb is higher at the charge polarity side (in this instance, at the negative polarity side) of the toner rather than at the surface potential of the toner layer which is generated by the charged toner carried on the developing roller 44. In this way, the restriction electric field Er of the direction shown in FIGS. 9C and 10 can be formed between the concave portion 442 of the developing roller 44 and the regulation blade 46, and the external additive Ad can be applied with charge of the same polarity as the charge polarity of the toner.

According to the experiment of the inventors, it is verified that when a metal oxide-based external additive, such as aluminum oxide (in particular, transition alumina), zinc oxide, cerium oxide, or tin oxide, is used, instead of the titanium oxide, the same effect was obtained. In particular, when an external additive with a higher insulation property than, for example silica, is added to increase coverage, the effect is considerable. Further, the insulating external additive of insulator, such as silica, of which the grain size is smaller than that of the metal oxide-based external additive is not a significant problem. However, the insulating external additive with larger grain size exerts a large effect on the charge characteristic of the toner. Consequently, it is preferable that more metal oxide-based external additives are added, more than the insulating external additive having such a large grain size. In this embodiment, since the contents of the external additive of silica having a large grain size (50 nm) is 0.5 wt %, at least the same amount, more preferably, larger amount of the metal oxide-based external additives may be added. Further, since it seems that if the contents of the insulating external additive with a small grain size are increased, the function of the metal oxide-based external additive is deteriorated, it is preferable that the metal oxide-based external additive of an amount equal to or more than the contents is added. In this embodiment, by increasing the contents of the titanium oxide having a grain size of 30 nm to 1 wt %, the contents are sufficiently larger than large-diameter silica (50 nm, 0.5 wt %) and is substantially equal to small-diameter silica (12 nm, 1 wt %).

In addition, it was verified that the effect is different depending upon surface treatment of the developing roller 44. For example, in a case in which the developing roller 44 is made of steel, good results are obtained by subjecting the surface thereof to an amorphous electroless plating process. A preferable process may include, for example, nickel/phosphorus plating process, nickel/tungsten plating process, nickel/boron/tungsten plating process and chrome carbide plating process. It seems that frictional charge of the toner easily occurs on the developing roller covered with an amorphous material, by sliding friction with the supply roller 43. It is verified that since the charge amount of the toner transferred to the contact position of the regulation blade 46 is increased, the charge amount of the toner can be easily adjusted by the regulation bias voltage Vrb.

Moreover, in a case in which the developing roller 44 is made of aluminum, if its surface is subjected to alumite process, a thin insulation film is formed on the surface of the developing roller 44. Therefore, insulation resistance between the developing roller 44 and the regulation blade 46 can be increased. In particular, even though the proportion of small-diameter toner or carbon black pigment is high, and the conductivity of the toner is high, the high withstand voltage can be assured while preventing the current leak. As a result, it is possible to enhance the controllability in the charge of the toner by applying sufficient regulation bias voltage Vrb. This is effective to promote the suppression of scattering and fogging in the small-diameter toner having lower insulation property or the high pigment toner.

Further, according to the thought of the invention, the conductivity is not necessary for the toner matrix particle itself, and in point of fogging suppression, if the conductivity is low, it is preferable that the charge control is easy by the conductive external additive, such as metal oxide. In this regard, toner produced by a polymerization method, of which the pigment is covered by a resin to suppress conductivity, may be used.

As described above, in this embodiment, the photoreceptor 22, the developing roller 44, and the regulation blade 46 serve as the “latent image carrier”, the “toner carrying roller”, and the “regulation blade” of the invention, respectively. Further, the developers 4Y, 4M, 4C, and 4K serve as the “developing device” of the invention. Moreover, the regulation bias power source 141 serves as the “bias applying unit” of the invention.

The invention is not limited to the embodiment, and may be variously modified beyond the above description unless it deviates from the technical scope of the invention. For example, the embodiment relates to the image forming apparatus of a so-called jumping developing type, in which a predetermined gap between the photoreceptor 22 and the developing roller 44 is spaced apart from each other to fly the toner therebetween, but the invention can be applied to an apparatus which applies AC developing bias in the state which the photoreceptor and the developing roller is in contact with each other.

Further, for example, the convex portions 441 of the developing roller 44 according to the embodiment are formed in a substantially diamond shape, but the shape of the convex portions is not limited thereto. For example, the convex shape may be a round shape, a triangular shape, or the other shape. In addition, it is not necessary all the same shape of the respective convex portions, and several shapes may be mixed. However, in any case, in order to obtain the effect of controlling the toner layer according to the invention, it is preferable that at least the top surface of the respective convex portions is configured to form a portion of the same cylindrical surface. Further, it is preferable that the depth of the concave portion is substantially uniform. In this regard, it is more effective that the concave portions are engraved on a smooth cylindrical surface to form the concave and convex portions.

The image forming apparatus according to the embodiment is a color image forming apparatus in which the rotary developing unit 4 is provided with the developer 4K and the like, but is not limited thereto. For example, the invention is applicable to a tandem color image forming apparatus in which a plurality of developers are arranged along an intermediate transfer belt, or a monochromatic image forming apparatus with only one developer forming a monochromatic image.

The entire disclosure of Japanese Patent Application No. 2009-070845, filed Mar. 23, 2009 is expressly incorporated by reference herein.

What is claimed is:

1. A developing device comprising:
a housing that stores toner therein;
a toner carrying roller that is mounted to the housing by a shaft and is rotated while carrying charged toner supplied from the housing on a surface of the toner carrying roller, in which a plurality of convex portions having top surfaces constituting a part of the same cylindrical surface and concave portions surrounding the convex portions are formed on the surface of the toner carrying roller; and
a conductive regulation blade having a free end extending toward an upstream side, in a rotation direction, of the toner carrying roller, in which the free end or a neighboring portion adjacent to the free end comes in contact with the surface of the toner carrying roller to regulate an amount of the toner carried on the surface of the toner carrying roller,
wherein the toner includes a conductive external additive as an external additive,
the toner carrying roller carries both contact toner which is in direct contact with the surface of the toner carrying roller and non-contact toner which is not in direct contact with the surface of the toner carrying roller, on the concave portion, and
the regulation blade is applied with a regulation bias voltage of the same polarity as a normal charge polarity of the toner.

2. The developing device according to claim 1, wherein a gap between a leading end of the free end and the concave portion of the toner carrying roller is larger than a volume average grain size of the toner.

3. The developing device according to claim 2, wherein a gap between the leading end of the free end and the convex portion of the toner carrying roller is 0.

4. The developing device according to claim 1, wherein the toner includes at least one of titanium oxide, aluminum oxide, zinc oxide, cerium oxide, and tin oxide as the external additive.

5. The developing device according to claim 1, wherein the toner carrying roller is made of metal with a surface which is subjected to an amorphous plating process.

6. An image forming apparatus comprising:
a housing that stores toner therein;
a toner carrying roller that is mounted to the housing by a shaft and is rotated while carrying charged toner supplied from the housing on a surface of the toner carrying roller, in which a plurality of convex portions having top surfaces constituting a part of the same cylindrical surface and concave portions surrounding the convex portions are formed on the surface of the toner carrying roller;
a conductive regulation blade having a free end extending toward an upstream side, in a rotation direction, of the toner carrying roller, in which the free end or a neighboring portion adjacent to the free end comes in contact with the surface of the toner carrying roller to regulate an amount of the toner carried on the surface of the toner carrying roller;
a bias applying unit that applies a predetermined regulation bias voltage to the regulation blade; and
a latent image carrier that is placed in opposite to the toner carrying roller and carries an electrostatic latent image on a surface thereof;
wherein the toner includes a conductive external additive as an external additive,
the toner carrying roller carries both contact toner which is in direct contact with the surface of the toner carrying roller and non-contact toner which is not in direct contact with the surface of the toner carrying roller, on the concave portion, and
the regulation bias voltage has the same polarity as a normal charge polarity of the toner.

7. The image forming apparatus according to claim 6, wherein the regulation bias voltage is larger than a surface potential of a toner layer carried on the surface of the toner carrying roller.

8. An image forming method comprising:
carrying toner on a surface of a toner carrying roller, in which a plurality of convex portions having top surfaces constituting a part of the same cylindrical surface and concave portions surrounding the convex portions are formed on the surface of the toner carrying roller;
regulating an amount of the toner by bring the surface of the toner carrying roller in contact with a conductive regulation blade having a free end extending toward an upstream side, in a rotation direction, of the toner carrying roller, in which the free end or a neighboring portion adjacent to the free end comes in contact with the surface of the toner carrying roller; and
placing a latent image carrier carrying an electrostatic latent image in opposite to the toner carrying roller to develop the latent image by the toner;
wherein the toner includes a conductive external additive as an external additive,
the toner carrying roller carries both contact toner which is in direct contact with the surface of the toner carrying roller and non-contact toner which is not in direct contact with the surface of the toner carrying roller, on the concave portion, and
the regulation blade is applied with a regulation bias voltage of the same polarity as a normal charge polarity of the toner.
